(19) United States
(12) Patent Application Publication
(10) Pub. No.: US 2025/0317044 A1
(43) Pub. Date: Oct. 9, 2025

(54) ADAPTIVE CONTROL FOR MULTI-LEVEL CONVERTERS

(71) Applicant: TEXAS INSTRUMENTS INCORPORATED, Dallas, TX (US)

(72) Inventors: Riccardo Ruffo, Freising (DE); Ivana Santrac, Freising (DE); Kelvin Le, Dallas, TX (US)

(21) Appl. No.: 19/022,765

(22) Filed: Jan. 15, 2025

Related U.S. Application Data
(60) Provisional application No. 63/631,562, filed on Apr. 9, 2024.

(51) Int. Cl. H02M 1/00; H02M 7/497

(52) U.S. Cl. CPC H02M 1/0083; H02M 1/0058; H02M 7/497

(57) ABSTRACT

An apparatus includes a two-level converter circuit, a higher-level converter circuit (having switches), and a controller. The controller receives a feedback signal associated with the two-level/higher-level converter circuits and generates a control signal based on the feedback signal. The apparatus operates in one of three modes (first/second/third modes) based on the control signal. In the first mode, the apparatus operates as a two-level converter to generate a two-level output voltage from an input voltage. In a second mode, the apparatus operates as a higher-level converter to increase a number of levels to more than two-levels for the output voltage. In a third mode, the apparatus transitions between the first/second modes where the apparatus operates as the two-level converter and where the switches of the higher-level converter circuit are activated for a period of time to generate a zero voltage at a switching connection point of the apparatus.

### RELATED APPLICATIONS

The instant application is a nonprovisional patent application that claims the benefit and priority to the U.S. Provisional Application No. 63/631,562, filed on Apr. 9, 2024, which is incorporated herein by reference in its entirety.

### BACKGROUND

High power applications have increased in recent years. For example, increasing numbers of electric vehicles (EV), renewable energy generation such as solar power, battery backup for solar panels, etc., have resulted in an increased number of high-power applications such as battery charging/discharging. Many high-power applications use traction inverters to convert a direct current (DC) to alternating current (AC). Some have used a three-level T-type converter (a three-level T-type converter is a three-level bidirectional power converter topology that converts a DC voltage to AC voltage or vice versa and that can operate as an inverter or a power factor correction device) or higher than three-level converters such as 4-level converters, to improve efficiency and electromagnetic interference (EMI) in comparison to lower-level converters such as two-level converters.

Multi-level converters may generate a sinusoidal voltage from multiple voltage levels, typically obtained from capacitor voltage sources. For example, in a three-level converter, each phase leg may include two pairs of switching devices in series. The resulting stair-step quasi-square wave output may be improved to approach a sinusoidal wave with an increased number of levels.

Three-level converters use more power switches in comparison to two-level converters, thereby increasing the cost. Power switches have low resistance between drain-source when the switch is on (RDSON), e.g., 5 mΩ, to support high current drives, e.g., 400 Amp. In general, in a T-type converter the outer power switches are rated for a full V_{bus} voltage. For example, for a V_{bus} of 800V, the outer switches may be rated at 1200V and the middle power switches can be rated for 600V, which is half of the 1200V rating of the outer switches. However, the current rating for the middle power switches and the outer power switches is still the same. Accordingly, low RDSON for the middle power switches is still needed in order to address the current rating even though the middle power switches can be rated for half of the full V_{bus} voltage. Accordingly, the cost associated with transitioning to a T-type converter is further increased due to the low RDSON rating associated with the middle power switches.

### SUMMARY

In an example, an apparatus includes a two-level converter circuit, a higher-level converter circuit, and a controller. The two-level converter circuit comprises a first switch and a second switch. The higher-level converter circuit comprises a third switch and a fourth switch. The controller is configured to receive a feedback signal associated with the two-level converter circuit and the higher-level converter circuit. The controller is configured to generate a control signal based on the feedback signal. The apparatus is configured to operate in one of three modes based on the control signal. In a first mode, the apparatus is configured to operate as a two-level converter, wherein the two-level converter is configured to generate a two-level output voltage from an input voltage. In a second mode, the apparatus is configured to operate as a higher-level converter, wherein the higher-level converter is configured to increase a number of levels to more than two-levels for the output voltage. In a third mode, the apparatus is configured to transition between the first mode and the second mode. Moreover, in the third mode, in response to the apparatus operating as the two-level converter and the third and the fourth switches of the higher-level converter circuit activated for a period of time, the apparatus is configured to generate a zero voltage at a switching connection point of the apparatus.

In an example, a method includes receiving a feedback signal associated with a multi-level converter circuit of an apparatus. The multi-level converter circuit includes a two-level converter circuit that includes a first switch and a second switch and a higher-level converter circuit that includes a third switch and a fourth switch. The method also includes generating a control signal based on the feedback signal. The control signal operates the multi-level converter circuit in one of a first mode, a second mode, or a third mode. In the first mode, the apparatus is configured to operate as a two-level converter and the two-level converter is configured to generate a two-level output voltage from an input voltage. In the second mode, the apparatus is configured to operate as a higher-level converter and the higher-level converter is configured to increase a number of levels to more than two-levels for the output voltage. In the third mode, the apparatus is configured to transition between the first mode and the second mode. Moreover, in the third mode, in response to the apparatus operating as the two-level converter and the third and the fourth switches of the higher-level converter circuit activated for a period of time, the multi-level converter circuit is configured to generate a zero voltage at a switching connection point of the apparatus.

### BRIEF DESCRIPTION OF THE DRAWINGS

FIG. 1 is a schematic diagram of an adaptive control system for a multi-level converter, in an example.

FIG. 2 is a schematic diagram of a multi-level converter, in an example.

FIG. 3 is a schematic diagram of a control system for generating a control signal for a power switch in a multi-level converter of FIG. 2, in an example.

FIG. 4 is a schematic diagram of another control system for generating a control signal for a power switch in a multi-level converter of FIG. 2, in an example.

FIG. 5A-5B show an apparatus operating as a two-level converter, in an example.

FIGS. 6A-6B show an apparatus operating as a three-level converter, in an example.

FIGS. 7A-7B show an apparatus operating in a transition mode between a two-level and three-level, in an example.

FIG. 8 shows operation of a multi-level converter, in another example.

FIG. 9 is a schematic diagram of an electric vehicle system with adaptive control for a multi-level converter, in an example.

FIG. 10 is schematic diagram of a 3-phase three-level T-type inverter, in an example.

FIG. 11 is a comparison of a performance between a conventional three-level converter and a multi-level converter that can operate in transitional mode, in an example.

FIG. 12 is a relation between conduction loss and junction temperature, in an example.

### DETAILED DESCRIPTION

The same reference numbers or other reference designators are used in the drawings to designate the same or similar (either by function and/or structure) features. Before various examples are described in greater detail, it should be understood that the examples are not limiting, as elements in such examples may vary. It should likewise be understood that a particular example described and/or illustrated herein has elements which may be readily separated from the particular example and optionally combined with any of several other examples or substituted for elements in any of several other examples described herein. It should also be understood that the terminology used herein is for the purpose of describing certain concepts, and the terminology is not intended to be limiting. Unless defined otherwise, all technical and scientific terms used herein have the same meaning as commonly understood in the art to which the examples pertain.

An adaptive control mechanism may be used to control the operation of a multi-level converter such that the multi-level converter can operate as a two-level converter, a higher-level converter (e.g., three-level converter, 4-level converter, etc.), or in a transitional mode (when transitioning from one level, e.g., two-level, to a higher-level converter) to improve efficiency and also to reduce cost. For example, a three-level T-type converter may be operated in a two-level or three-level or in a transitional mode, as desired, to improve its efficiency and EMI. The cost associated with the three-level T-type converter may be reduced by allowing the middle power switches of the T-type converter to be replaced with lower cost switches (e.g., MOSFET with high RDSON such as 20-40 mΩ) with low capacitance output, e.g., 150 pF, instead of having to be rated for high current (e.g., low RDSON such as 2-6 mΩ) of a conventional 3-L type converters. Moreover, during transitional mode, at least one of the middle switches may be activated for a short amount of time to cause the output voltage to become approximately 0 volt for a short amount of time. As such, the overall switching losses of the apparatus are reduced due to the impact of the reduced switching losses on the outer switches. According to an example, a feedback signal (e.g., switching terminal current, junction temperature, etc.) associated with the middle power switches may be used to generate a control signal (e.g., pulse width modulation (PWM)) for controlling each switch (e.g., one or more switches of the middle power switches and/or the outer power switches) of the T-type converter. The configuration according to the nonlimiting examples enables the apparatus to operate as a two-level converter or three-level converter (or higher-level converter) while enabling the apparatus to operate in a transitional mode when transitioning between a converter from a level to another level, e.g., from a two-level converter to three-level converter, from three-level converter to two-level converter, from three-level converter to 4-level converter, etc. At light loads, the adaptive control mechanisms, as described herein, improve the efficiency of up to 50% and the EMI in comparison to a conventional two-level converter while at heavy loads efficiencies up to 30% is realized.

It is appreciated that throughout this application, the examples are provided with respect to a three-level T-type converter for illustration purposes and should not be construed as limiting the scope of the examples. For example, the discussion with respect to a three-level converter in a T-type converter is equally applicable to 4-level or higher-level converters that may or may not be in a T-type configuration. Throughout the specification, references are being made to a two-level converter where two-level output voltage is generated from an input voltage. Moreover, references are being made to a higher-level converter where the number of output voltages generated from the input voltage is increased in comparison to the two-level converter, e.g., three output voltages for a three-level converter, four output voltages for a 4-level converter, etc. It is appreciated that the terms operation, regulation, and mode have been used throughout this application interchangeably.

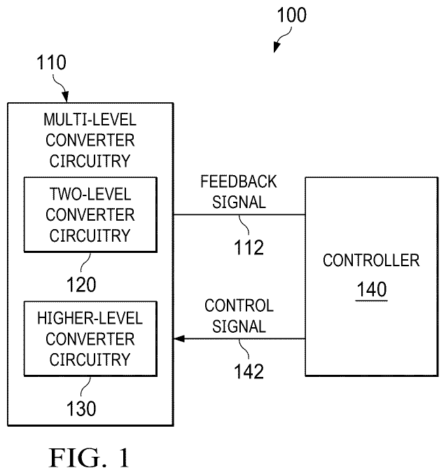

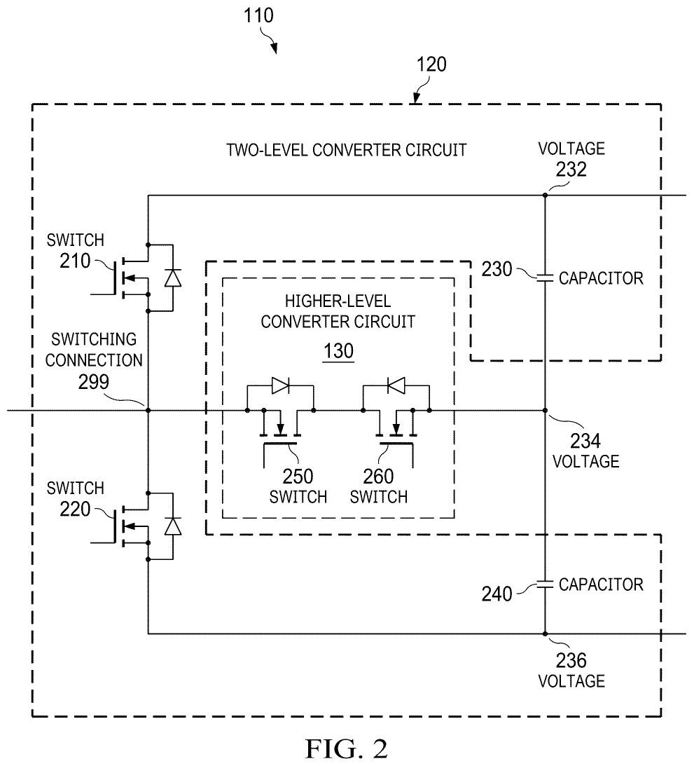

FIG. 1 is a schematic diagram of an adaptive control system 100 for a multi-level converter, in an example. The system 100 includes a multi-level converter circuitry 110 coupled to a controller 140. The multi-level converter circuitry 110 includes a two-level converter circuitry 120 and a higher-level converter circuitry 130. According to an example, the two-level converter circuitry 120 is a converter with two levels and the higher-level converter circuitry 130 is a circuitry that changes the two-level converter circuitry 120 to a higher-level converter, e.g., three-level, four-level, etc. In one example, the two-level converter circuitry 120 generates two voltage outputs from an input voltage. In one example, the two-level converter circuitry 120 includes power switches (also referred to as outer power switches) and the higher-level converter circuitry 130 includes power switches (also referred to as middle power switches), as described in greater detail in FIG. 2. The higher-level converter circuitry 130 is configured to generate more than two voltage outputs when it is activated with the two-level converter circuitry 120. In one example, the multi-level converter circuitry 110 may be a three-level T-type converter. The multi-level converter circuitry 110 may generate a feedback signal 112 (e.g., switching terminal current, junction temperature, etc.) that is used by the controller 140, e.g., a central processor unit (CPU), a microcontroller, a field programmable gate array (FPGA), application specific integrated circuit (ASIC), etc., to generate a control signal 142 (e.g., a PWM signal) for controlling one or more power switches of the multi-level converter circuitry 110.

The controller 140 generates the control signal 142 that causes the apparatus (e.g., multi-level converter circuitry 110) to operate in one of three modes. The first mode may be associated with the multi-level converter circuitry 110 operating as a two-level converter, thereby generating two output voltages (i.e., two levels). The second mode may be associated with the multi-level converter circuitry 110 operating as a higher-level converter, e.g., three-level converter, 4-level converter, etc., thereby generating more than two output voltages such as 3 output voltages. The third mode of operation is when transitioning between a converter from a level to another level, e.g., from a two-level converter to three-level converter, from three-level converter to two-level converter, from three-level converter to 4-level converter, etc. In the third mode, the controller 140 causes one or more switches of the higher-level converter 130 to become activated for a period of time to generate approximately a zero voltage at a switching connection 299 of the multi-level converter 110. As such, the overall switching losses of the apparatus are reduced due to the impact of the reduced switching losses on the outer switches.

It will be apparent that the components portrayed in this figure and subsequent figures can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

Referring now to FIG. 2, a schematic diagram of a multi-level converter 110, in an example, is shown. The multi-level converter 110 in the example of FIG. 2 is a three-level T-type 1-phase converter circuit. The multi-level converter 110 includes a two-level converter circuit 120 that includes power switches 210-220 (outer power switches) and capacitors 230-240. The power switches 210-220 may be low RDSON, e.g., 2-6 mΩ. The higher-level converter circuit 130 in FIG. 2 is a circuitry that converts the two-level converter circuit 120 to a three-level converter circuit and it includes power switches 250 and 260 (middle power switches). The power switches 250 and 260 are positioned in between the power switches 210 and 220 and capacitors 230 and 240 of the two-level converter circuit 120. The power switches 250 and 260 may be lower cost switches (e.g., MOSFET high RDSON such as 20-40 mΩ) with low capacitance output, e.g., 150 pF, instead of having to be rated for high current (e.g., low RDSON such as 2-6 mΩ) of a conventional 3-L type converters.

In one example, the feedback signal 112 may be a signal associated with the switching terminal current of the higher-level converter circuit 130. For example, the feedback signal 112 in FIG. 2 may be the switching terminal current of the power switches 250 and 260 of the higher-level converter circuit 130. In one example, the switching terminal current may be measured using an inductor (not shown) connected to the power switches 250 and 260. In one nonlimiting example, the current may be measured through a different mean, e.g., Hall effect, shunt based solution, current transformer, etc. In yet another example, the feedback signal 112 in FIG. 2 may be the junction temperature associated with the power switches 250-260 of the higher-level converter circuit 130. According to one example, the junction temperature may be measured using a diode or by a GaN device that may be responsible for power conversion that is also capable of measuring the temperature of the GaN device. In one example, temperature may be measured internally in the power device using a temperature sensor or may be estimated by measuring parameters, e.g., real time measuring of RDSON, associated with a switch, e.g., FET. In one example, the GaN device or the diode may measure the junction temperature associated with a power switch 250 and/or 260. The feedback signal 112 that may include the switching terminal current and/or junction temperature is sent to the controller 140 for processing.

The controller 140 generates the control signal 142 that causes the apparatus (e.g., multi-level converter circuitry 110) to operate in one of three modes. The first mode may be associated with the multi-level converter circuitry 110 operating as a two-level converter, thereby generating two output voltages (i.e., two levels). In the first mode, the higher-level converter circuit 130 in inactivated, e.g., disabling power switches 250 and 260.

The second mode may be associated with the multi-level converter circuitry 110 operating as a higher-level converter, e.g., three-level converter, 4-level converter, etc., thereby generating more than two output voltages such as 3 output voltages for a three-level converter. In one nonlimiting example, in the second mode, the controller 140 controls the power switches such that power switches 210 and 260 switch while power switch 250 is asserted and power switch 220 is de-asserted (disabled). In one nonlimiting example, in the second mode, the controller 140 controls the power switches such that power switches 220 and 250 are switching while power switch 260 is asserted and power switch 210 is de-asserted (disabled).

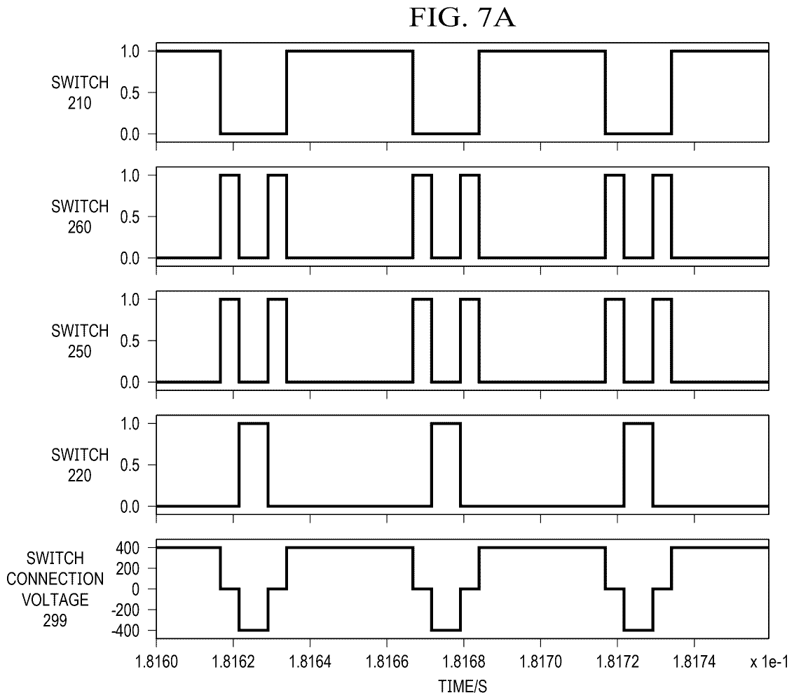

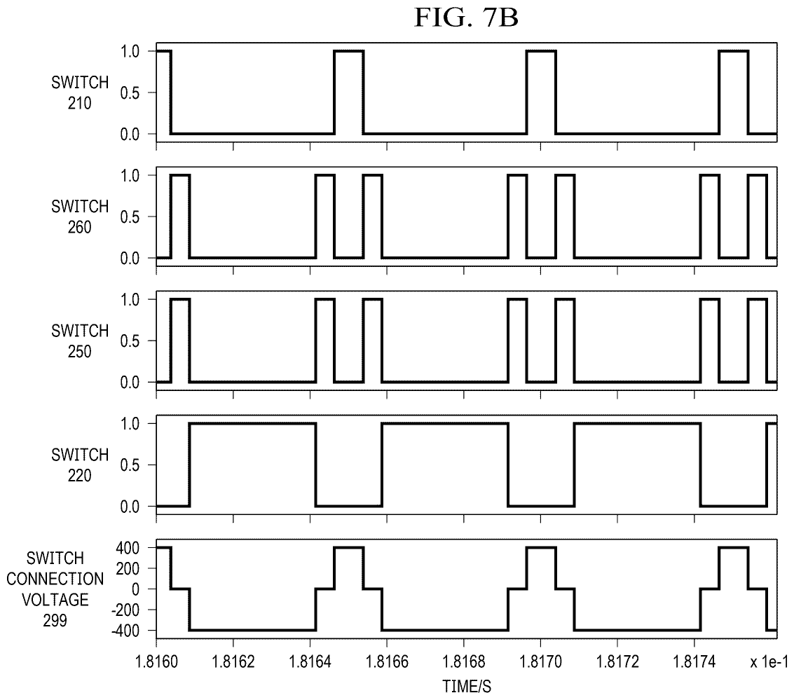

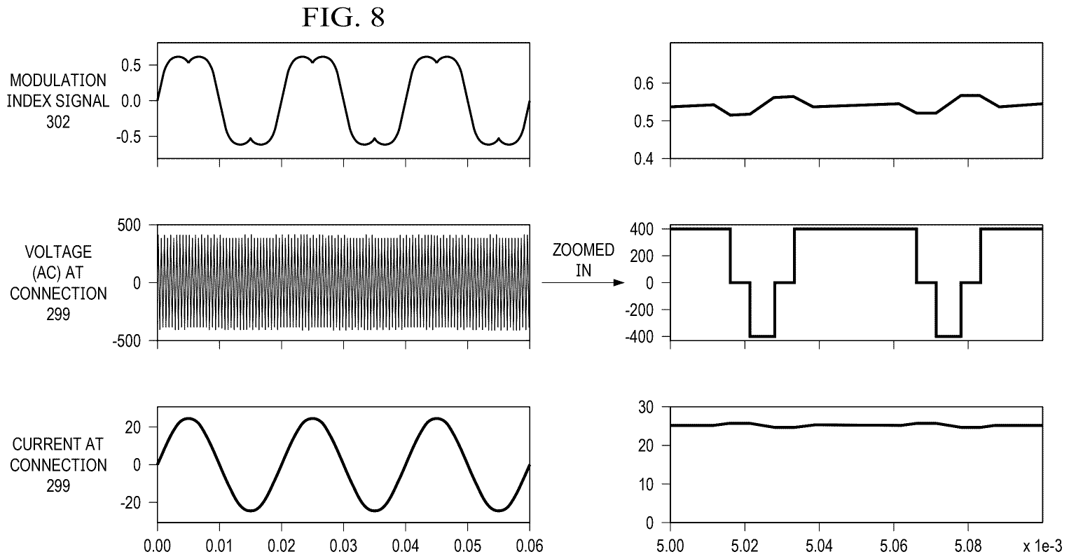

The third mode of operation is when transitioning between a converter from one level to another level, e.g., from a two-level converter to three-level converter, from three-level converter to two-level converter, from three-level converter to 4-level converter, etc. In the third mode, the controller 140 causes one or more switches of the higher-level converter 130 to become activated for a period of time to generate approximately a zero voltage at a switching connection 299 of the multi-level converter 110. As such, the overall switching losses of the apparatus are reduced due to the impact of the reduced switching losses on the outer switches. Examples of operations of the power switches in the third mode is provided in FIGS. 7A-7B. Voltages 232, 234 and 236 are described with respect to FIG. 8 below.

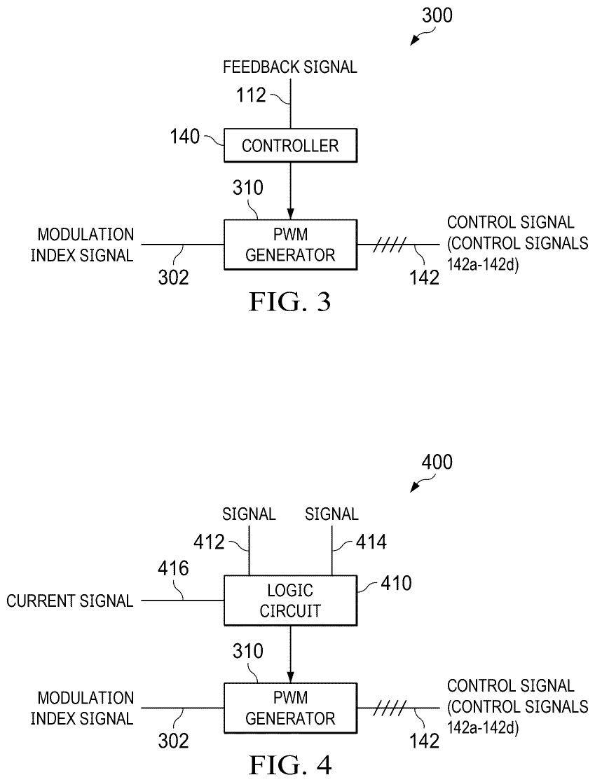

FIG. 3 is a schematic diagram of a control system 300 for generating a control signal for a power switch in a multi-level converter of FIG. 2, in an example. The control system 300 includes a PWM generator 310 and the controller 140. In one example, the modulation index signal 302 (whether externally generated or created by the controller 140) is input to the PWM generator 310 to generate a PWM signal associated with the mode of operation, e.g., first mode (two-level), second mode (three-level), third mode (transitioning between two different levels), etc., for the multi-level converter 110 as controlled by the controller 140. In an example the controller 140 receives the feedback signal 112 and controls the PWM generator 310 to generate appropriate PWM signals (e.g., control signal 142 that includes signals 142a-142d associated with power switches 210, 220, 250, and 260 respectively) for controlling each of the power switches 210, 220, 250, and 260 in order to operate the multi-level converter circuit 110 in one of three modes. According to some examples, the two-level and three-level modes or transition between two different levels (e.g., one level converter to another level converter) may be performed within a same cycle of the sinusoidal waveform that is being controlled, e.g., a 3-L PWM signal is used for current peak up to 40 Amp and a 2-L PWM signal is used for current peak from 40-200 Amp.

In this example, for a three-level converter with four power switches, four control signals may be output (one for each power switch). For example, one control signal may be generated to control the power switch 210, one control signal may be generated to control the power switch 220, one control signal may be generated to control the power switch 250, and one control signal may be generated to control the power switch 260. As such, the PWM generator 310 may generate four PWM signals (one for each power switch) to operate the converter in any given level, e.g., two-level, three-level, transition, etc.

Discussions with respect to one control signal for each power switch is for illustrative purposes and should not be construed as limiting the scope of the examples. For example, one control signal may be used to control the operation of power switches (e.g., switches 210-220) of the two-level converter circuit 120 while one control signal may be used to control the operation of the power switches (e.g., switches 250-260) of the higher-level converter circuit 130.

In one example, a memory component may be used to store a lookup table (LUT) that is accessed by the controller 140 to determine the control signal 142. The LUT may be stored and implemented to improve efficiency by determining the PWM signal associated with a particular power switch based on the feedback signal 112. For example, the LUT may have a corresponding PWM signal (for a given power switch such as switch 210 or 220 or 250 or 260) associated with a particular feedback signal (e.g., switching terminal current and/or junction temperature, etc.). In other words, the LUT may indicate a particular PWM signal to be used for a given switch (e.g., switch 210, switch 220, switch 250, switch 260) based on the feedback signal (e.g., based on a switching terminal current and/or junction temperature). Below is an example of a table associated with switch 210. A similar table may be used for other power switches of the multi-level converter circuitry. According to one example, the LUT associated with each power switch may be the same or different from one another. In other words, controlling each power switch may be programmable (via the LUT) and the operation of each power switch may be controlled based on the feedback signal.

| Feedback Signal (switching terminal | PWM |
|---|---|
| current, junction temperature, etc.) | Signal |
| a₁ | PWM₁ |
| a₂ | PWM₂ |
| a₃ | PWM₃ |
| . . . | . . . |
| aₙ | PWMₙ |

According to one example, based on the determined PWM signal, the controller 140 controls the PWM generator 310 to output the desired PWM signal, as the control signal 142. The control signal 142 is sent to the multi-level converter 110 in order to control the operation of the power switches. In one example, the control signal 142 may include multiple signals (e.g., control signals 142a, 142b, 142c, and 142d) to control multiple power switches.

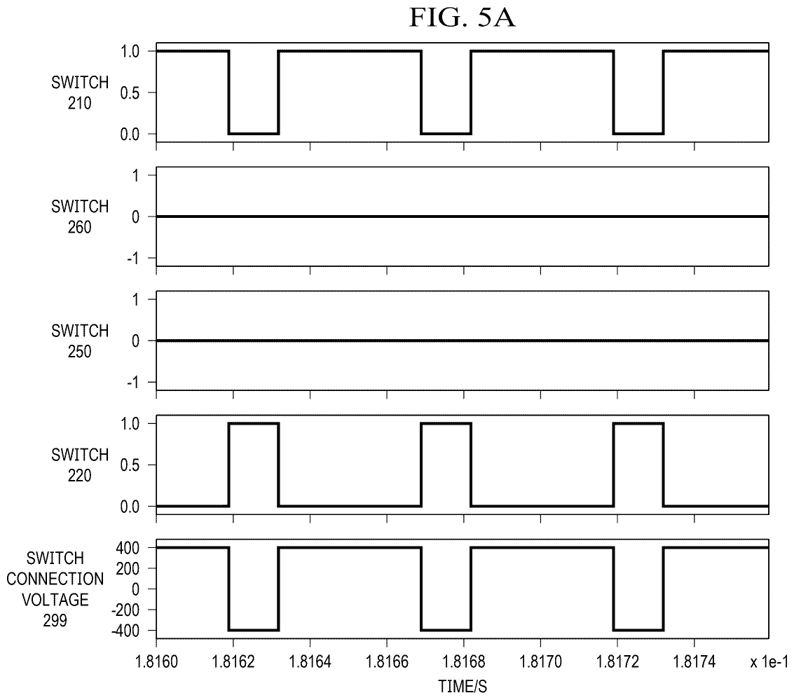

FIG. 4 is a schematic diagram of another control system 400 for generating a control signal for a multi-level converter of FIG. 2, in an example. FIG. 4 is similar to FIG. 3 except that a logic circuit 410 is used instead of the controller 140. The logic circuit 410 may include one or more logical circuits (e.g., AND gate, OR gate, NOR gate, XOR gate, etc.). The logic circuit 410 may receive the current signal 416 and signals 412-414 as its feedback signal. The current signal 416 is a signal associated with the switching terminal current, as described above. The signals 412 and 414 may be signals associated with junction temperatures of power switches 250 and 260 respectively. The logic circuit 410 based on the received signals (e.g., current signal 416 and/or signal 412 and/or signal 414) controls the operation of the PWM generator 310 to generate the appropriate PWM signal for each power switch, as the control signal 142 (e.g., control signals 142a-142d).

It is appreciated that the control systems 300 or 400, as described above, may be replicated for each phase of the system. For example, a control system 300 or 400, as described above, may be replicated for each phase of a 3-phase converter, e.g., one control system for the first phase, one control system for the second phase, and one control system for the third phase.

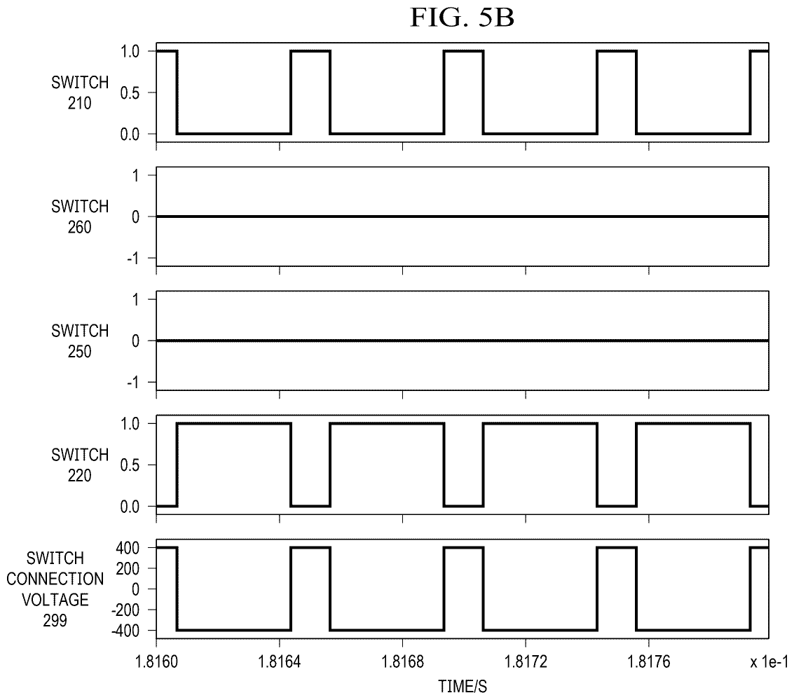

FIG. 5A-5B show an apparatus operating as a two-level converter, in an example. In FIG. 5A the controller 140 has determined that the multi-level converter 110 should be operated in the first mode (e.g., as a two-level converter) based on the feedback signal 112. In one nonlimiting example, the controller 140 causes the PWM generator 310 to generate appropriate PWM signal for each power switch. In this example, the PWM signal generated for the power switch 210 causes the switches 210 and 220 to switch opposite to one another, e.g., when switch 210 is asserted switch 220 is de-asserted, when switch 210 is de-asserted switch 220 is asserted. In other words, controlling the switches, as described above, controls the dead time between the switches (e.g., when the voltage is forced to 0 V). The duty cycle associated with each switch 210 and 220 may be controlled by the PWM generator 310 based on controller 140. In this nonlimiting example, power switches 250 and 260 are de-asserted (using the PWM signal generated by the PWM generator 310) to disable the higher-level converter circuit 130, thereby operating the apparatus as a two-level converter circuit. In this example, the mean value voltage to be achieved in the switch connection voltage 299 with respect to connection having a voltage 234 is approximately 200 V (mean value of 200 V) with a DC link voltage of 400 V. Referring now to FIG. 5B, a variation of FIG. 5A is shown where the duty cycle of the switches 210 and 220 is varied and where the mean value voltage of −200 V with a DC link voltage of 400 V is achieved.

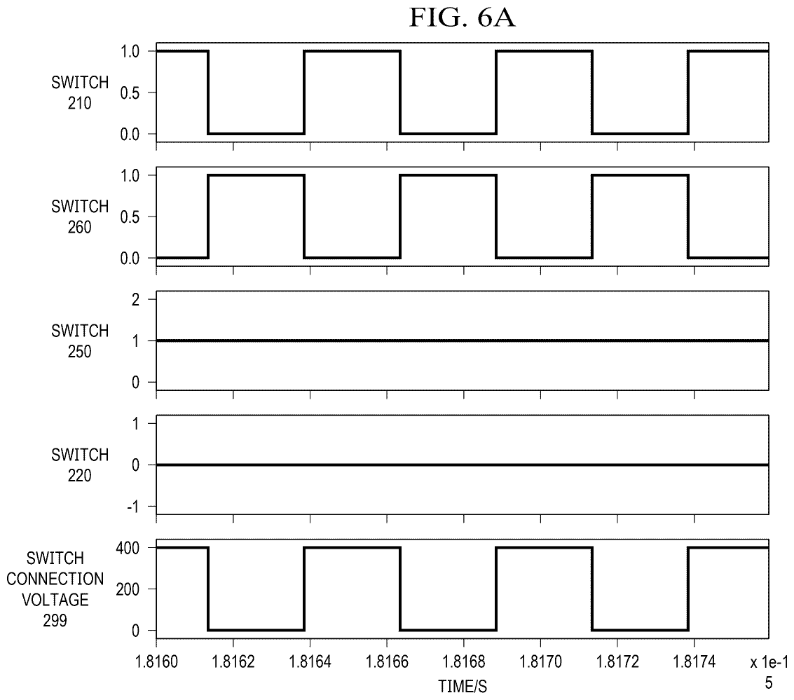

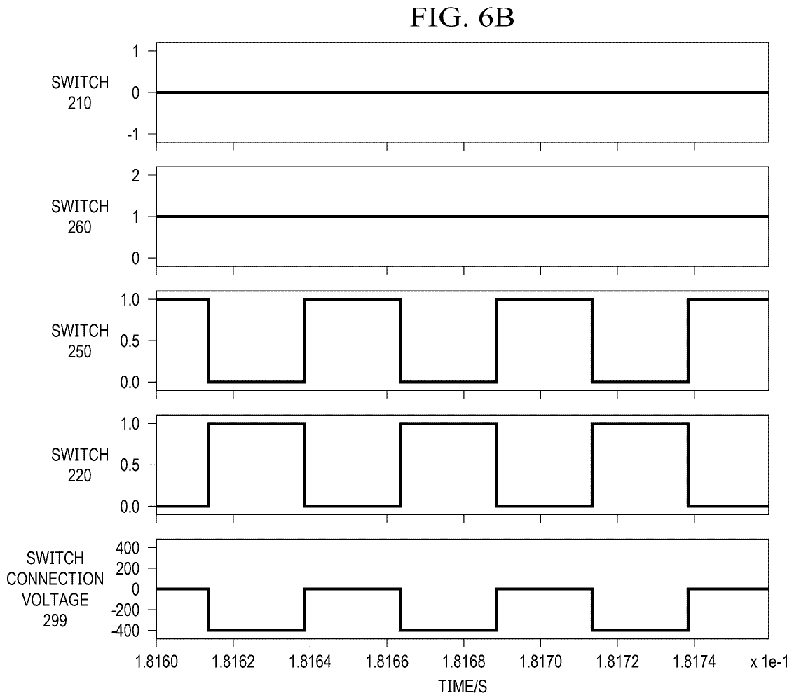

FIGS. 6A-6B show an apparatus operating as a three-level converter, in an example. In FIG. 6A the controller 140 has determined that the multi-level converter 110 should be operated in the second mode (e.g., as a three-level converter) based on the feedback signal 112. In one nonlimiting example, the controller 140 causes the PWM generator 310 to generate appropriate PWM signal for each power switch. In this example, the PWM signal generated for the power switches causes the switch 210 and switch 260 to switch opposite to one another (when the switch 210 is asserted the switch 260 is de-asserted and when the switch 210 is de-asserted the switch 260 is asserted) while the switch 250 is asserted and switch 220 is de-asserted. In other words, controlling the switches, as described above, controls the dead time between the switches (e.g., when the voltage is forced to 0 V). In this example, the mean value voltage of 200 V with a DC link voltage of 400 V is achieved at the switching connection voltage 299.

FIG. 6B shows another example similar to FIG. 6A. In this example, the switch 210 is de-asserted (switch disabled) while switch 260 is asserted and where switches 220 and 250 are switched opposite to one another (e.g., when the switch 250 is asserted the switch 220 is de-asserted and when the switch 250 is de-asserted the switch 220 is asserted). In other words, controlling the switches, as described above, controls the dead time between the switches (e.g., when the voltage is forced to 0 V). In this nonlimiting example, the mean value voltage of −200 V is achieved at the switching connection voltage 299 with a DC link voltage of 400 V.

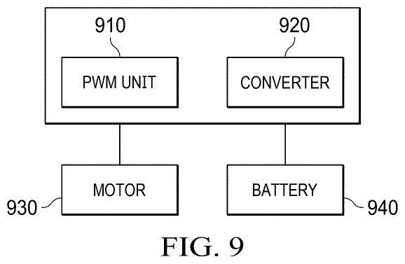

FIGS. 7A-7B show an apparatus operating in a transition mode between a two-level and three-level, in an example. In FIG. 7A, the controller 140 has determined that the multi-level converter 110 should be operated in the third mode (e.g., transitioning between two different levels such as two-level converter to three-level converter or from three-level converter to two-level converter) based on the feedback signal 112. In one nonlimiting example, the controller 140 causes the PWM generator 310 to generate appropriate PWM signal for each power switch. In this nonlimiting example, the controller 140 causes the switch 210 and 220 to switch such that when the switch 210 is asserted switch 220 is de-asserted and when the switch 210 is de-asserted then switch 220 is asserted for only a period of time within which the switch is de-asserted (e.g., switch 220 asserted for a quarter of the time period that switch 210 is de-asserted, switch 220 asserted for a third of the time period that switch 210 is de-asserted, etc.). During the period of time (also referred to as transitioning time) that both switches 210 and 220 are de-asserted, switches 250 and 260 may be activated to generate approximately 0 V at the switching connection 299 of the multi-level converter 110. In some examples, the transitioning time may be adjusted based on the junction temperature, current associated with the switching connection voltage 299, etc. In a motor application such as the one described in FIG. 9 below, the transitioning time may be adjusted based on the length of the cable that connects the motor to the inverter. The overall switching losses of the apparatus are reduced due to the impact of the reduced switching losses on the outer switches. In this nonlimiting example, the switches 250 and 260 are activated twice during each period of time that both the switch 210 and switch 220 are de-asserted, thereby generating a 0 V at the switching connection 299. Generating two 0 V at the switching connection 299 at each period of time that both switches 210 and 220 are de-asserted is for illustrative purposes and should not be construed as limiting the scope of the examples. For example, in another nonlimiting example, during the time period where switch 210 is de-asserted, the switch 220 is activated twice or more than two times, and therefore activating switches 250 and 260 during the period where both switches 210 and 220 are de-asserted generated 0 V three times or more. The voltage at the switching connection 299 is also illustrated. In this example, the mean voltage of 200 V is achieved with a DC link voltage of 400 V.

In FIG. 7B, the controller 140 has determined that the multi-level converter 110 should be operated in the third mode (e.g., transitioning between two different levels such as two-level converter to three-level converter or from three-level converter to two-level converter) based on the feedback signal 112. In one nonlimiting example, the controller 140 causes the PWM generator 310 to generate appropriate PWM signal for each power switch. In this example, the controller 140 causes the switch 210 and 220 to switch such that when the switch 210 is asserted the switch 220 is de-asserted and that the switch 210 is asserted for at least a subset of time that the switch 220 is de-asserted (e.g., switch 210 asserted for a quarter of the time period that switch 220 is de-asserted, switch 210 asserted for a third of the time period that switch 220 is de-asserted, etc.). During the period of time that both switches 210 and 220 are de-asserted, switches 250 and 260 may be activated to generate approximately 0 V at the switching connection 299 of the multi-level converter 110. In some examples, the transitioning time may be adjusted based on the junction temperature, current associated with the switching connection voltage 299, etc. The overall switching losses of the apparatus are reduced due to the impact of the reduced switching losses on the outer switches. In this nonlimiting example, the switches 250 and 260 are activated twice during each period of time that the switch 210 and switch 220 are de-asserted, thereby generating a 0 V at the switching connection 299. Generating two 0 V at the switching connection 299 at each period of time that both switches 210 and 220 are de-asserted is for illustrative purposes and should not be construed as limiting the scope of the examples. For example, in another nonlimiting example, during the time period where switch 210 is de-asserted, the switch 220 is activated twice or more than two times, and therefore activating switches 250 and 260 during the period where both switches 210 and 220 are de-asserted generated 0 V three times or more. The voltage at the switching connection 299 is also illustrated. In this example, the mean voltage of −200 V is achieved with a DC link voltage of 400 V.

According to some nonlimiting examples, the switches 250-260 are deactivated (in first mode) when the controller 140 operates the multi-level converter 110 as a two-level converter. In one nonlimiting example, when the controller 140 operates the multi-level converter 110 as a three-level converter, the switch 210 is deactivated (de-asserted) when the switch 220 is switching and the switch 250 is asserted (turned on) when the switch 260 is switching. The control signals associated with the switches 210, 220, 250 and 260 are controlled by the controller 140 controlling the PWM generator 310. In one example, the switch 210 is turned on (asserted) and the switch 220 is turned off (de-asserted) or vice versa while switches 210 and 260 are not asserted at the same time (same period of time) and while the switches 220 and 250 are not asserted at the same time (same period of time). The power switches 250 and 260 may be lower cost switches (e.g., high RDSON such as 20-40 mΩ) with low MOSFET capacitance output, e.g., 150 pF, instead of having to be rated for high current (e.g., low RDSON such as 2-6 mΩ) of a conventional 3-L type converters. The parasitic capacitance is reduced because of higher RDSON for switches 250 and 260 while enabling faster switching (lower crossover loss for switches 250 and 260).

FIG. 8 shows operation of a multi-level converter, in another example. In this example, the modulation index signal 302 is illustrated with the voltage (AC) at the connection 299 and the current at connection 299. The example illustrates that while it appears that the converter is performing a 2-L switching operation, once zoomed in, it is clear that the converter is performing a 3-L switching, as described above. FIG. 8 also shows the switching node voltage 299 (DC voltage) as well as the current through the connection 299. Accordingly, switches 210 and 220 may be rated for DC voltage of 1200 V while the switches 250 and 260 may be rated at a much lower voltage 600/650 V.

FIG. 9 is a schematic diagram of an electric vehicle system with adaptive control for a multi-level converter, in an example. The EV system may include a PWM unit 910, a converter 920, a motor 930 and a battery 940. The PWM unit 910 may be similar to the system 300 or 400 of FIG. 3 or 4 respectively to generate a control signal associated with power switches of the converter 920 circuitry (e.g., multi-level converter circuitry 110). The battery 940 is an electric storage for supplying power for the motor 930. The PWM unit 910 and the converter 920 may be traction inverters for the EV. According to one nonlimiting example, the motor overvoltage caused by a long cable connecting the inverter to the motor may be mitigated by using the PWM unit 910 and the converter 920, as described above. For example, the transitioning mode time may be tuned with respect to the length of the cable and the propagation speed of the signal in the power cable.

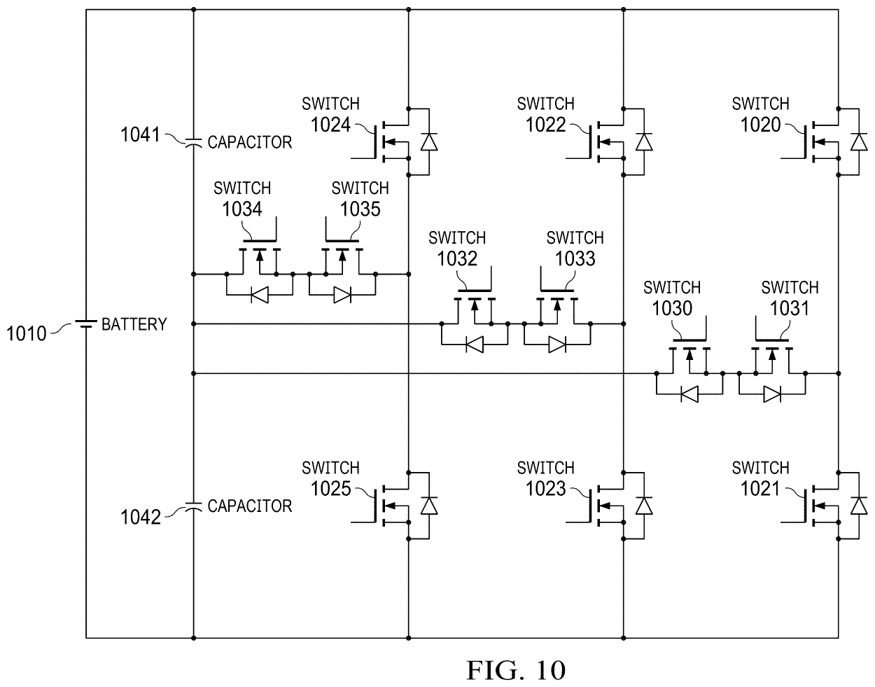

FIGS. 1-9 described 1-phase converters for illustration purposes that should not be construed as limiting the scope. For example, FIG. 10 is schematic diagram of a 3-phase three-level T-type inverter, in an example. In FIG. 10, the outer power switches 1020-1025 are associated with the two-level converter circuitry whereas the middle power switches 1030-1035 are associated with the higher-level converter circuitry (e.g., three-level). In an example, the 3-phase three-level T-type inverter may also include capacitors 1041 and 1042 and a battery 1010.

According to an example, a PWM signal (control signal) may be generated for each power switch, e.g., switches 1021-1035 in FIG. 10. In other words, 12 PWM signals may be generated, one for each power switch. In another example, one control signal may be generated to control switches 1034-1035, one control signal may be generated to control switches 1032-1033, one control signal may be generated to control switches 1030-1031, one control signal may be generated to control switch 1020, etc. In yet another example, one control signal may be generated to control more than one of the outer power switches, e.g., switches 1021-1025.

According to one example, the feedback signal may include one or more of switching current terminal for switches 1034-1035, switching current terminal for switches 1032-1033, switching current terminal for switches 1030-1031, junction temperature for switch 1030, junction temperature for switch 1031, junction temperature for switch 1032, junction temperature for switch 1033, junction temperature for switch 1034, junction temperature for switch 1035, etc. Accordingly, the number of feedback signals, the type of feedback signals, etc., may be changed as desired to control the operation of each power switch. In other words, the number of feedback signals, the type of feedback signals, the number of control signals, etc., is configurable and controllable to control the operation of one or more power switches of the converter circuitry.

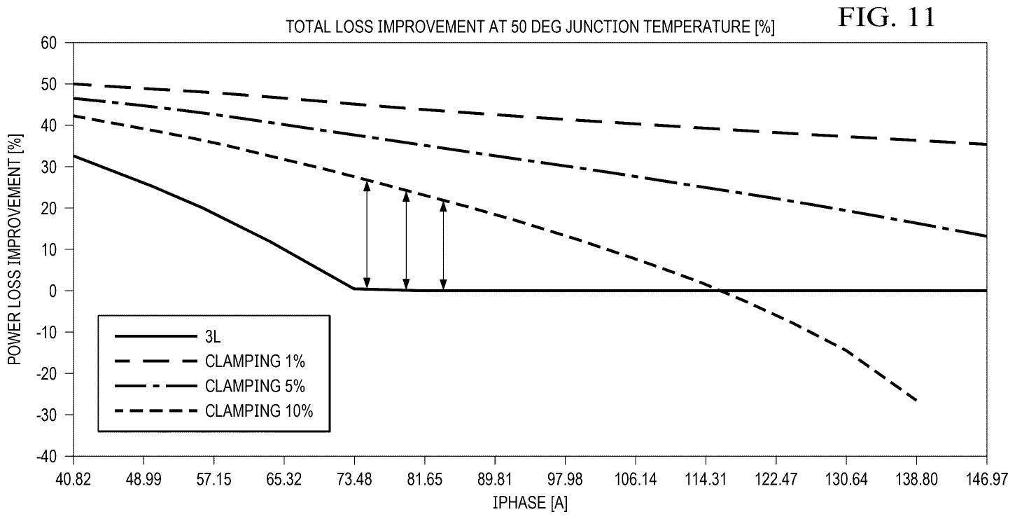

FIG. 11 is a comparison of a performance between a conventional three-level converter and a multi-level converter that can operate in transitional mode, in an example. FIG. 11 illustrates that at 50 degrees junction temperature under conventional three-level converter, the power loss is substantially reduced but once a current threshold is reached, power loss increases, and it is not efficient to be driven in the three-level mode. In comparison, the adaptively switching the middle switches to operate in the transitional mode, as described in FIGS. 1-10, results in further reduction of power loss at high loads. As illustrated, in one example, the converter may be operated in three-level operation until the 73 Amp threshold, and at which point the power loss cannot be reduced under three-level operation. As such, the system controls the power switches to operate in a transitional mode at or above 65 Amp in one example to switch the middle switches of the higher-level converter circuit 130 to achieve further reduction in power loss, as shown. The results at a 50 degree junction temperature is provided for illustration purposes and should not be construed as limiting the scope of the examples. At light loads, the adaptive control mechanisms, as described above, improve the efficiency of up to 50% and the EMI in comparison to a conventional two-level converter while at heavy loads efficiencies up to 30% is realized.

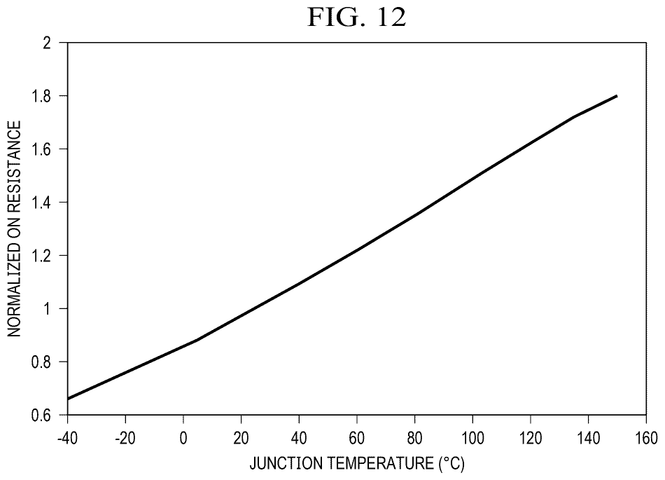

FIG. 12 is a relation between conduction loss and junction temperature for a GaN device, in an example. As illustrated, conduction losses are dependent on the junction temperature in GaN devices. As such, monitoring the junction temperature in real time and controlling the operation of power switches (using PWM signals) enables efficiency and EMI to be improved and further to allow longer three-level regulation even at a high load.

Accordingly, the real time current (switching terminal current) from one or more power switches (e.g., middle power switches) and/or one or more junction temperature associated with one or more power switches (e.g., middle power switches) may be used control the operation of the power switches (e.g., middle power switches and/or outer power switches) to operate the converter as a three-level T-type over the full range of loads, thereby improving the efficiency, as a two-level T-type, or in a transitional mode where the middle switches are activated for a short period of time to generate approximately 0 voltage at the connection 299 to reduce loss. As such, the overall switching losses of the apparatus are reduced due to the impact of the reduced switching losses on the outer switches. The power switches 250 and 260 may be lower cost switches (e.g., high RDSON such as 20-40 mΩ) with low capacitance output, e.g., 150 pF, instead of having to be rated for high current (e.g., low RDSON such as 2-6 mΩ) of a conventional 3-L type converters while losses associated with switches is reduced by activating the middle switches as described above.

As described above, the configuration and examples provided in FIGS. 1-12 enables the controller to control the PWM generator to operate the converter as a two-level converter, a three-level converter, a higher-level converter, or in a transitional mode where the output voltage is forced to approximately 0 by activating the middle switches of the higher-level circuitry 130. The operation may occur within an electrical cycle depending on the current and/or temperature provided as the feedback signal. Controlling the operation of the converter enables the middle power switches to be rated for lower current (e.g., high RDSON), thereby reducing the cost in comparison to a fully rated multi-level inverter while still enabling high efficiencies, lower EMI, and less partial discharge (on the motor side) to be achieved. In one example, in a motor application, the adaptive control for the multi-level converter enables the DC current in the motor to be in a low speed/stalling condition while the junction temperature and/or current is used to switch in three-level until an appropriate temperature threshold is reached. According to an example, the adaptive control for controlling the operation of the multi-level converter, as described above, is used at lower operating temperature to improve battery efficiency. According to an example, the middle power switches may operate at high current for a short period of time even though they may not be rated for high current, as described above, thereby reducing the cost. In other words, even when the phase current has a high amplitude, the middle power switches may operate for a certain period of time within one cycle. Furthermore, activating the middle switches to force approximately 0 voltage at the connection 299 results in lowering losses associated with the switches (e.g., achieve higher power loss reduction at high loads), as described above.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. An apparatus comprising:
a two-level converter circuit comprising a first switch and a second switch;
a higher-level converter circuit comprising a third switch and a fourth switch; and
a controller configured to receive a feedback signal associated with the two-level converter circuit and the higher-level converter circuit,
wherein the controller is configured to generate a control signal based on the feedback signal,
wherein the apparatus is configured to operate in one of three modes based on the control signal,
wherein in a first mode, the apparatus is configured to operate as a two-level converter, wherein the two-level converter is configured to generate a two-level output voltage from an input voltage,
wherein in a second mode, the apparatus is configured to operate as a higher-level converter, wherein the higher-level converter is configured to increase a number of levels to more than two-levels for the output voltage, and
wherein in a third mode, the apparatus is configured to transition between the first mode and the second mode,
and wherein in the third mode, in response to the apparatus operating as the two-level converter and the third and the fourth switches of the higher-level converter circuit activated for a period of time, the apparatus is configured to generate a zero voltage at a switching connection point of the apparatus.

2. The apparatus of claim 1, wherein the feedback signal is an amount of current being drawn by the two-level converter circuit and the higher-level converter circuit.

3. The apparatus of claim 1, wherein the feedback signal is associated with a temperature associated with the third or fourth switch of the higher-level converter circuit.

4. The apparatus of claim 1, wherein the control signal is a pulse width modulation (PWM) signal.

5. The apparatus of claim 1, wherein the third and the fourth switches are deactivated in the first mode.

6. The apparatus of claim 1, wherein the first switch is turned off while the second switch is switching and the third switch is turned on while the fourth switch is switching when the apparatus is in the second mode.

7. The apparatus of claim 1, wherein in the third mode the first, the second, the third, and the fourth switches are switching based on the control signal.

8. The apparatus of claim 1, wherein when the first switch is turned on the second switch is tuned off and vice versa, and wherein the first switch and the fourth switch are not turned on at a same time and wherein the second switch and the third switch are not turned on at a same time.

9. The apparatus of claim 1, wherein the controller is a pulse width modulation (PWM) unit, and wherein the controller is configured to generate a pulse width modulation (PWM) signal associated with each of the first switch, the second switch, the third switch, and the fourth switch.

10. The apparatus of claim 1, wherein the first switch or the second switch of the two-level converter circuit is rated to support current to approximately 200-400 Amp and has a resistance between drain-source when the first switch or the second switch of the two-level converter circuit is on (RDSON) of approximately 2-6 mΩ and wherein the third switch or the fourth switch of the higher-level converter circuit has RDSON of approximately 20-40 mΩ.

11. The apparatus of claim 1, wherein the two-level converter circuit is a three-phase circuit.

12. The apparatus of claim 1, wherein the higher-level converter circuit is a T-type converter.

13. A method comprising:
receiving a feedback signal associated with a multi-level converter circuit of an apparatus, wherein the multi-level converter circuit includes a two-level converter circuit that includes a first switch and a second switch and a higher-level converter circuit that includes a third switch and a fourth switch;
generating a control signal based on the feedback signal, wherein the control signal operates the multi-level converter circuit in one of a first mode, a second mode, or a third mode,
wherein in the first mode, the apparatus is configured to operate as a two-level converter, wherein the two-level converter is configured to generate a two-level output voltage from an input voltage,
wherein in the second mode, the apparatus is configured to operate as a higher-level converter, wherein the higher-level converter is configured to increase a number of levels to more than two-levels for the output voltage, and
wherein in the third mode, the apparatus is configured to transition between the first mode and the second mode,
and wherein in the third mode, in response to the apparatus operating as the two-level converter and the third and the fourth switches of the higher-level converter circuit activated for a period of time, the multi-level converter circuit is configured to generate a zero voltage at a switching connection point of the apparatus.

14. The method of claim 13, wherein the feedback signal is a current being drawn by the multi-level converter circuit.

15. The method of claim 13, wherein the feedback signal is associated with a temperature associated with the third or fourth switch of the higher-level converter circuit.

16. The method of claim 13, wherein the control signal is a pulse width modulation (PWM) signal.

17. The method of claim 13 further comprising deactivating the third and the fourth switches in the first mode.

18. The method of claim 13, wherein the second mode the method further comprises:
switching the second switch;
turning off the first switch;
turning on the third switch; and
switching the fourth switch.

19. The method of claim 13, wherein in the third mode the method further comprises switching the first, the second, the third, and the fourth switches based on the control signal.

20. The method of claim 13, wherein when the first switch is turned on the second switch is tuned off and vice versa, and wherein the first switch and the fourth switch are not turned on at a same time and wherein the second switch and the third switch are not turned on at a same time.

21. The method of claim 13, wherein at least one switch of the two-level converter circuit is rated to support current to approximately 200-400 Amp and has a resistance between drain-source when the at least one switch of the two-level converter circuit is on (RDSON) of approximately 2-6 mΩ and wherein the at least another switch of the higher-level converter circuit has RDSON of approximately 20-40 mΩ.

22. The method of claim 13, wherein the control signal includes a pulse width modulation signal (PWM) for each of the first switch, the second switch, the third switch, and the fourth switch.
